(19) United States
(12) Patent Application Publication
(10) Pub. No.: US 2022/0312789 A1
(43) Pub. Date: Oct. 6, 2022

(54) TEA BEVERAGE

(71) Applicants: ASAHI GROUP HOLDINGS, LTD., Tokyo (JP); ASAHI SOFT DRINKS Co., LTD., Tokyo (JP)

(72) Inventors: Tomoki TAKAGISHI, Moriya Shi (JP); Ayako YAMADA, Moriya Shi (JP)

(21) Appl. No.: 17/615,527

(22) PCT Filed: Aug. 18, 2020
(86) PCT No.: PCT/JP2020/031106

§ 371 Date: Nov. 30, 2021

(30) Foreign Application Priority Data
Sep. 2, 2019 (JP) 2019-159811

(51) Int. Cl. A23F 3/40; A23L 2/52

(52) U.S. Cl. CPC A23F 3/405; A23L 2/52; A23V 2002/00

(57) ABSTRACT

A tea beverage containing an extract derived from a grain other than barley which has improved barley tea flavor without losing the flavor characteristics of the grain ingredient. The tea beverage contains an extract derived from a grain other than barley, and contains one or both of 2-ethyl-3,5-dimethylpyrazine and 2,3-diethyl-5-methylpyrazine. If the beverage contains 2-ethyl-3,5-dimethylpyrazine, the amount thereof is 8-100 ppb, and if the beverage contains 2,3-diethyl-5-methylpyrazine, the amount thereof is 0.7-100 ppb. The feedstock grain is one or more of Job's tears, brown rice, and corn.

### TECHNICAL FIELD

The present invention relates to a tea beverage. The present invention relates more specifically to a tea beverage containing an extract derived from a grain other than barley, wherein the tea beverage has improved barley tea flavor.

### BACKGROUND ART

For example, a tea beverage containing an extract liquid extracted from a plurality of feedstocks such as tea leaves and grains (also called a “mixed tea beverage”) is strongly supported by health-conscious consumers because such a tea beverage enables easy intake of various components derived from the feedstocks. Thirsty-proofness by barley tea-like taste has been required for such a mixed tea beverage in recent years.

As to a tea beverage having thirsty-proofness, for example, Patent Document 1 proposes technology of a packaged barley tea beverage having thirsty-proofness and refreshing feeling even though the barley tea beverage is drunk lukewarm in addition to being drunk cold. Patent Document 1 specifically discloses that a tea beverage having thirsty-proofness and refreshing feeling can be prepared by adjusting the total polysaccharide amount of the starch and the Q-glucan, the maltose amount, the rate of soluble solid contents derived from barley, and the ratio of the amount of a phenol-based compound group to that of a pyrazine-based compound group, which is fragrance components, to respective predetermined ranges, and can be suitable for drinking. Patent Document 2 also proposes a packaged barley tea beverage produced based on the same technical idea.

Here, in order to improve barley tea flavor for giving good thirsty-proofness to a tea beverage, increasing the amount of barley ingredient incorporated is generally conceivable as an example. However, a problem is that incorporation of a barley ingredient for improving barley tea flavor may result in loss of flavor characteristics of other grain ingredients.
Patent Document 1: Japanese Unexamined Patent Application, Publication No. 2012-217347
Patent Document 2: Japanese Unexamined Patent Application, Publication No. 2012-217348

### DISCLOSURE OF THE INVENTION

### Problems to be Solved by the Invention

The present invention has been proposed in view of such actual situation, and an object of the present invention is to provide a tea beverage containing an extract derived from a grain other than barley, wherein the tea beverage has improved barley tea flavor without losing the flavor characteristics of the grain ingredient.

### Means for Solving the Problems

The present inventors have repeated examination earnestly to achieve the above-mentioned object. Consequently, the present inventors have found that the barley tea flavor can be improved without losing the flavor characteristics of the grain ingredient by incorporating a specific fragrance component at a predetermined proportion into a tea beverage containing an extract derived from a grain at least other than barley, and completed the present invention.

(1) A first invention of the present invention is a tea beverage containing an extract derived from a grain other than barley, comprising: one or both of 2-ethyl-3,5-dimethylpyrazine and 2,3-diethyl-5-methylpyrazine, wherein a content of the 2-ethyl-3,5-dimethylpyrazine is 8-100 ppb, and a content of the 2,3-diethyl-5-methylpyrazine is 0.7-100 ppb.

(2) A second invention of the present invention is the tea beverage according to the first invention, wherein the grain is one or more selected from Job's tears, brown rice, and corn.

(3) A third invention of the present invention is a method for producing a tea beverage containing an extract derived from a grain other than barley, comprising: a step of extracting a grain extract liquid from a feedstock grain other than barley; and a step of adding one or both of 2-ethyl-3,5-dimethylpyrazine and 2,3-diethyl-5-methylpyrazine to the grain extract liquid so that a content of the 2-ethyl-3,5-dimethylpyrazine is 8-100 ppb and a content of the 2,3-diethyl-5-methylpyrazine is 0.7-100 ppb.

(4) A fourth invention of the present invention is a method for improving barley tea flavor of a tea beverage, comprising: adding one or both of 2-ethyl-3,5-dimethylpyrazine and 2,3-diethyl-5-methylpyrazine to a tea beverage containing an extract derived from a grain other than barley so that a content of the 2-ethyl-3,5-dimethylpyrazine is 8-100 ppb and a content of the 2,3-diethyl-5-methylpyrazine is 0.7-100 ppb.

### Effects of the Invention

According to the present invention, a tea beverage containing an extract derived from a grain other than barley can be provided, wherein the tea beverage has improved barley tea flavor without losing the flavor characteristics of the grain ingredient.

### PREFERRED MODE FOR CARRYING OUT THE INVENTION

Hereinafter, specific embodiments of the present invention will be described in detail. The present invention is not limited to the following embodiments and can be modified variously as long as the gist of the present invention is not changed. The expression “X-Y” (X and Y are any numerical values) herein means “X or more and Y or less”.

### 1. Tea Beverage

A tea beverage according to the present invention is a tea beverage containing an extract derived from a grain other than barley. Here, the “tea beverage” herein means a liquid beverage containing tea extract liquid extracted from a roasted grain and tea leaves, and contains at least an extract liquid of the roasted grain. This tea beverage includes not merely liquid consisting only of tea extract liquid extracted from one certain type of grain but also liquid obtained by diluting such a tea extract liquid; by mixing extract liquid from other grains and tea leaves into such tea extract liquid; or by adding additives to the liquid, or liquid prepared by dispersing materials obtained by drying the liquid, or the like.

This tea beverage contains one or both fragrance components of 2-ethyl-3,5-dimethylpyrazine and 2,3-diethyl-5-methylpyrazine. When the tea beverage contains 2-ethyl-3,5-dimethylpyrazine, a content thereof in the tea beverage is 8-100 ppb, and when the tea beverage contains 2,3-diethyl-5-methylpyrazine, a content thereof in the tea beverage is 0.7-100 ppb.

Even when the tea beverage contains both of 2-ethyl-3,5-dimethylpyrazine and 2,3-diethyl-5-methylpyrazine, the contents of each component in the tea beverage are in the above-mentioned respective ranges.

Extract Derived from a Grain

The tea beverage according to the present invention contains an extract derived from a grain other than barley and is a tea beverage containing extract liquid at least from the grain as obtained by roasting.

A grain commonly used as a feedstock of a tea beverage can be used as the grain, and examples thereof include Job's tears, brown rice, corn, soybean, azuki bean, and potato.

Among those, the grain is preferably one or more selected from the group consisting of Job's tears, brown rice, and corn. If the extract is derived from these grains, the extract is excellent in an effect produced by incorporating a fragrance component mentioned below in detail at a specific rate, and namely while the barley tea flavor is improved, the flavor characteristics of the grain ingredient is maintained and improved effectively.

The presence of an extract of barley, which is a grain, in this tea beverage is acceptable, that is, the tea beverage may contain an extract of barley in addition to an extract derived from a grain other than barley.

As mentioned above, an extract of a grain as a feedstock is obtained by an extraction treatment commonly performed to obtain an extract such as an extract liquid from a grain, tea leaves, or the like. For example, when Job's tears are used as a feedstock grain, an extract liquid containing components included in Job's tears can be collected by performing extraction treatment with an extracting solvent for Job's tears. The feedstock grain may be subjected to treatment such as roasting or pulverizing, or may not be subjected to the treatment.

### Fragrance Component

First, 2-ethyl-3,5-dimethylpyrazine and 2,3-diethyl-5-methylpyrazine are compounds belonging to pyrazines and are fragrance components. The tea beverage according to the present invention contains one or both of 2-ethyl-3,5-dimethylpyrazine and 2,3-diethyl-5-methylpyrazine.

It is known that these fragrance components are contained in barley. The present inventors have found that the barley tea flavor can be effectively improved in the tea beverage containing an extract derived from a grain other than barley by incorporating the above-mentioned fragrance components among many fragrance components contained in barley at specific contents. Besides, the present inventors have found that the barley tea flavor can be improved without losing the flavor characteristics of the grain ingredient.

These fragrance components are not particularly limited, and can be incorporated by using commercial items of the compound. As mentioned above, it is known that these fragrance components are contained in barley and other grain components in a very small amount, and these fragrance components can also be incorporated by using an extract liquid of such components and components isolated from the extract liquid.

The contents of 2-ethyl-3,5-dimethylpyrazine and 2,3-diethyl-5-methylpyrazine in the tea beverage can be adjusted by the amounts of the compounds incorporated into the tea beverage. For example, in the tea beverage containing an extract of grain components, or the like, the contents of 2-ethyl-3,5-dimethylpyrazine and 2,3-diethyl-5-methylpyrazine are adjusted including the content of 2-ethyl-3,5-dimethylpyrazine and the content of 2,3-diethyl-5-methylpyrazine contained in the extract of the grain components.

The contents of 2-ethyl-3,5-dimethylpyrazine and 2,3-diethyl-5-methylpyrazine can be measured, for example, by using a gas chromatograph-mass spectrometer (GC-MS). When the concentrations in feedstocks can be grasped, the contents can also be calculated.

### Content of 2-ethyl-3,5-dimethylpyrazine

When the tea beverage according to the present invention contains 2-ethyl-3,5-dimethylpyrazine, the content thereof in the tea beverage is in the range of 8-100 ppb. When the tea beverage contains 2,3-diethyl-5-methylpyrazines at the same time, the content of 2-ethyl-3,5-dimethylpyrazine is in the above-mentioned range.

When the content of 2-ethyl-3,5-dimethylpyrazine which is a fragrance component is 8 ppb or more, the barley tea flavor can be improved. The content is preferably 10 ppb or more, more preferably 20 ppb or more, and particularly preferably 50 ppb or more.

When the content of 2-ethyl-3,5-dimethylpyrazine is 100 ppb or less, the barley tea flavor can be improved without losing the flavor characteristics of the grain ingredient contained in the tea beverage. The content is preferably 90 ppb or less, more preferably 80 ppb or less, and particularly preferably 70 ppb or less.

### Content of 2,3-diethyl-5-methylpyrazine

When the tea beverage according to the present invention contains 2,3-diethyl-5-methylpyrazine, the content thereof in the tea beverage is in the range of 0.7-100 ppb. When the tea beverage contains 2-ethyl-3,5-dimethylpyrazine at the same time, the content of 2,3-diethyl-5-methylpyrazine in the tea beverage is in the above-mentioned range.

When the content of 2,3-diethyl-5-methylpyrazine, which is a fragrance component, is 0.7 ppb or more, the barley tea flavor can be improved. The content is preferably 7 ppb or more, more preferably 10 ppb or more, and particularly preferably 50 ppb or more.

When the content of 2,3-diethyl-5-methylpyrazine is 100 ppb or less, the barley tea flavor can be improved without losing the flavor characteristics of the grain ingredient contained in the tea beverage. The content is preferably 90 ppb or less, more preferably 80 ppb or less, and particularly preferably 70 ppb or less.

### Combined Use of 2-ethyl-3,5-dimethylpyrazine and 2,3-diethyl-5-methylpyrazine

As mentioned above, 2-ethyl-3,5-dimethylpyrazine and 2,3-diethyl-5-methylpyrazine can be incorporated in combination into the tea beverage according to the present invention. The contents of the components in the tea beverage at this time are in the same ranges as mentioned above. That is, the content of 2-ethyl-3,5-dimethylpyrazine is 8-100 ppb and the content of 2,3-diethyl-5-methylpyrazine is 0.7-100 ppb in the tea beverage.

Thus, when the tea beverage contains 2-ethyl-3,5-dimethylpyrazine and 2,3-diethyl-5-methylpyrazine, and for example, the content ratio between the contents is adjusted in the above-mentioned content ranges (for example, adjusted to 1:1 in the content mass ratio), the barley tea flavor can be improved without losing the flavor characteristics of the grain ingredient.

### Other Components

As long as the effect of the tea beverage according to the present invention is not inhibited, other feedstocks and additives usually used for common tea beverages can be optionally blended into the tea beverage. The amounts incorporated can be optionally adjusted depending on the intended effect. The tea beverage may specifically contain various additives such as an antioxidant, a pH adjuster, a perfume, various esters, organic acids, organic acid salts, inorganic acids, inorganic acid salts, inorganic salts, coloring agents, an emulsifier, a preservative, a seasoning, and a quality stabilizer.

### Container

The tea beverage according to the present invention can be filled into a container to produce a packaged tea beverage.

The container may be a hermetic container known in the beverage industry, can be suitably selected and used, and can be suitably determined depending on the distribution form or consumer needs. Specific examples thereof include hermetic containers made of a single material such as glass, plastic (polyethylene terephthalate (PET), polyethylene (PE), polypropylene (PP), or the like), paper, aluminum, and steel, or a composite material or a laminated material thereof. In particular, transparent containers (including translucent containers) are preferable. The transparent containers may be wholly transparent or may be partially transparent.

### 2. Method for Producing Tea Beverage

The tea beverage according to the present invention is a tea beverage containing the extract derived from the grain other than barley, and can be produced by suitably adjusting the contents of the above-mentioned fragrance components and incorporating the above-mentioned fragrance components into the grain extract liquid extracted from the feedstock grain other than barley.

This method for producing a tea beverage specifically has a step of extracting grain extract liquid from a feedstock grain other than barley and a step of adding one or both of 2-ethyl-3,5-dimethylpyrazine and 2,3-diethyl-5-methylpyrazine to the grain extract liquid so that the contents are respective predetermined amounts. More specifically, when 2-ethyl-3,5-dimethylpyrazine is contained, it is added so that the content thereof is 8-100 ppb. When 2,3-diethyl-5-methylpyrazine is contained, it is added so that the content thereof is 0.7-100 ppb.

The method for adding 2-ethyl-3,5-dimethylpyrazine and/or 2,3-diethyl-5-methylpyrazine to grain extract liquid may be performed according to the usual method. For example, extract liquids containing components provided in respective predetermined amounts, and the like are added sequentially or simultaneously. The tea beverage can be produced by adding components followed by mixing such as stirring. The order of mixing feedstocks, and the like are not particularly limited.

The produced tea beverage can be filled into a container to produce a packed tea beverage. A sterilization treatment is optionally performed before or after the container is filled.

### 3. Method for Improving Barley Tea Flavor of Tea Beverage

As mentioned above, the tea beverage according to the present invention is a tea beverage containing the extract derived from the grain other than barley and has the effect which enables improving barley tea flavor without losing the flavor characteristics of the grain ingredient by incorporating one or both fragrance components of 2-ethyl-3,5-dimethylpyrazine and 2,3-diethyl-5-methylpyrazine at specific contents.

That is, incorporation of one or both of 2-ethyl-3,5-dimethylpyrazine and 2,3-diethyl-5-methylpyrazine into the tea beverage containing the extract derived from the grain other than barley at respective specific rates can be defined as the method for improving the barley tea flavor of the tea beverage. Specifically, in the case of 2-ethyl-3,5-dimethylpyrazine, it is added so that the content thereof is 8-100 ppb, and in the case of 2,3-diethyl-5-methylpyrazine, it is added so that the content thereof is 0.7-100 ppb.

By incorporating one or both fragrance components of 2-ethyl-3,5-dimethylpyrazine and 2,3-diethyl-5-methylpyrazine so that the contents thereof are in a specific range based on such a method, the barley tea flavor can be improved effectively, and moreover, the flavor characteristics of the feedstock grain ingredient are not lost simultaneously.

### EXAMPLES

Although specific Examples of the present invention will be shown hereinbelow, the present invention is not limited to the following Examples.

### Test 1: Inspection of Effect of 2-ethyl-3,5-dimethylpyrazine

### Preparation of Job's Tears Extract Liquid

90 g of roasted and pulverized Job's tears (L value: 36) was subjected to extraction with 2700 g of pure water at 90° C., the resultant was filtered through a filter No. 2, and then cooled to obtain an extract liquid. To the obtained extract liquid were added 2.7 g of L-sodium ascorbate, 0.9 g of L-ascorbic acid, and 1.8 g of sodium bicarbonate, and the mixture was diluted to 9000 g with pure water to obtain a preparation liquid. The obtained preparation liquid was sterilized with UHT (at 140° C. for 30 seconds) and then aseptically filled into a bottle to obtain sterilized Job's tears extract liquid. The concentration of 2-ethyl-3,5-dimethylpyrazine contained in the obtained sterilized Job's tears extract liquid was 1.1 ppb, and the concentration of 2,3-diethyl-5-methylpyrazine contained therein was 0.13 ppb. Preparation of barley extract liquid (“barley tea flavor” standard sample)

90 g of roasted and pulverized barley (L value: 34.5) was subjected to extraction with 2700 g of pure water at 90° C., the resultant was filtered through a filter No. 2, and then cooled to obtain an extract liquid. To the obtained extract liquid were added 2.7 g of L-sodium ascorbate, 0.9 g of L-ascorbic acid, and 1.8 g of sodium bicarbonate, and the mixture was diluted to 9000 g with pure water to obtain a preparation liquid. The obtained preparation liquid was sterilized with UHT (at 140° C. for 30 seconds) and then aseptically filled into a bottle to obtain sterilized barley extract liquid. The concentration of 2-ethyl-3,5-dimethylpyrazine contained in the obtained sterilized barley extract liquid was 1.7 ppb, and the concentration of 2,3-diethyl-5-methylpyrazine contained therein was 0.20 ppb.

Production of Tea Beverages which were Articles Under Test

To the prepared sterilized Job's tears extract liquid was added 2-ethyl-3,5-dimethylpyrazine so that the contents thereof were 6-200 ppb to produce tea beverages which were test samples.

The contents of 2-ethyl-3,5-dimethylpyrazine in the tea beverages were measured by using a gas chromatograph-mass spectrometer (GC-MS). Specifically, a vial bottle (capacity: 10 ml) was charged with 100 μl of the beverage which is an analysis subject and introduced into a GC-MS (manufactured by Agilent Technologies Japan, Ltd.) by the MVM (Multi Volatile Method) which uses MPS manufactured by GERSTEL K.K. The calibration curve was prepared by a standard addition method, and cyclohexanol was used as an internal standard substance.

### Analysis Conditions of GC-MS

Apparatus GC: Agilent 7980B GC System (manufactured by Agilent Technologies Japan, Ltd.)
   MS: Agilent 7000D GC/MS Triple Quad (manufactured by Agilent Technologies Japan, Ltd.)
   Collecting tube (adsorbent): Tenax TA, Carbopack-B & Carbopack-X
Column: DB-WAX UI, 20 m×0.18 mm, film thickness: 0.30 μm (manufactured by Agilent Technologies Japan, Ltd.)
Injection method: Splitless
Carrier gas: He (1.0 ml/minute)
Transfer line: 250° C.
Temperature raising program: 40° C. (maintained for 3 minutes)→5° C./minute→240° C. (maintained for 7 minutes)
Precursor ion>product ion (CE (collision energy)): 2-ethyl-3,5-dimethylpyrazine 135>135 (5 V)
Ionizing method: EI
Quadrupole temperature: 150° C.
Ion source temperature: 230° C.

### Sensory Evaluation

Six professional panelists performed a sensory evaluation. Specifically, the “barley tea flavor” and the “Job's tears flavor” were scored on a scale of one to seven (one point: “no”—seven points: “considerably strong”) separately, and the average values were calculated. The “barley tea flavor” was evaluated by using the prepared sterilized barley extract liquid as a standard (marks: four points) and by using the prepared sterilized Job's tears extract liquid (2-ethyl-3,5-dimethylpyrazine was not added) as a control (marks: one point). The “Job's tears flavor” was evaluated by using the prepared sterilized Job's tears extract liquid (2-ethyl-3,5-dimethylpyrazine was not added) as a standard (marks: four points).

As mentioned above, it means that as the scores become higher, the “barley tea flavor” and the “Job's tears flavor” become stronger. It was determined that a tea beverage wherein the “barley tea flavor” was two points or more and “barley tea flavor”<“Job's tears flavor” had an effect, namely the effect of improving barley tea flavor without losing Job's tears flavor.

TABLE 1

| | | Comparative | | | Comparative |
|---|---|---|---|---|---|
| [Test_1] | Control_1 | Example_1 | Example_1 | Example_2 | Example_2 |
| 2-Ethyl-3,5- | 1.1 | 6 | 50 | 100 | 200 |
| dimethylpyrazine | | | | | |
| Concentration | | | | | |
| (ppb) | | | | | |
| Barley Tea | 1.0 | 1.3 | 2.3 | 2.3 | 2.8 |
| Flavor | | | | | |
| Job's Tears | 4.0 | 4.0 | 3.2 | 2.8 | 2.3 |
| Flavor | | | | | |

As shown in Table 1, in Examples 1 and 2, the barley tea flavor was improved in the tea beverages containing Job's tears extract liquid by adding 2-ethyl-3,5-dimethylpyrazine. Decrease in Job's tears flavor accompanying the improvement of barley tea flavor was also suppressed, and the characteristic flavor of Job's tears was not lost, either.

Meanwhile, in Comparative Example 1 in which 2-ethyl-3,5-dimethylpyrazine was added at a content of as low as 6 ppb, the Job's tears flavor did not decrease while the effect of improving barley tea flavor was barely observed. In Comparative Example 2 in which 2-ethyl-3,5-dimethylpyrazine was added so that the content thereof was as high as 200 ppb, the barley tea flavor was improved while Job's tears flavor decreased therewith, and the characteristic flavor of Job's tears was lost.

### Test 2: Inspection of Effect of 2,3-diethyl-5-methylpyrazine Production of tea beverages which were articles under test

Sterilized Job's tears extract liquid was prepared in the same way as in test 1, and 2,3-diethyl-5-methylpyrazine was then added to the sterilized Job's tears extract liquid so that the content thereof was 0.5-200 ppb to produce tea beverages which are test samples.

The content of 2,3-diethyl-5-methylpyrazine in the tea beverage was measured under the following conditions by using a gas chromatograph-mass spectrometer (GC-MS) in the same way as in test 1.

### Analysis Conditions of GC-MS

Apparatus GC: Agilent 7980B GC System (manufactured by Agilent Technologies Japan, Ltd.)
   MS: Agilent 7000D GC/MS Triple Quad (manufactured by Agilent Technologies Japan, Ltd.)
   Collecting tube (adsorbent): Tenax TA, Carbopack-B & Carbopack-X
Column: DB-WAX UI, 20 m×0.18 mm, film thickness: 0.30 μm (manufactured by Agilent Technologies Japan, Ltd.)
Injection method: Splitless
Carrier gas: He (1.0 ml/minute)
Transfer line: 250° C.
Temperature raising program: 40° C. (maintained for 3 minutes)→5° C./minute→240° C. (maintained for 7 minutes)
Precursor ion>product ion (CE (collision energy)): 2,3-diethyl-5-methylpyrazine 150>135 (10 V)
Ionizing method: EI
Quadrupole temperature: 150° C.
Ion source temperature: 230° C.

Sensory Evaluation

The “Barley tea flavor” and the “Job's tears flavor” were scored on a scale of one to seven separately as to the tea beverages produced in the same way as in test 1, and the average values were calculated. The “barley tea flavor” was evaluated by using the prepared sterilized barley extract liquid as a standard (marks: four points) and by using the prepared sterilized Job's tears extract liquid (2,3-diethyl-5-methylpyrazine was not added) as a control (marks: one point). The “Job's tears flavor” were evaluated by using the prepared sterilized Job's tears extract liquid (2,3-diethyl-5-methylpyrazine was not added) as a standard (marks: four points). It was determined that a tea beverage wherein the “barley tea flavor” was two points or more and “barley tea flavor”<“Job's tears flavor” had an effect, namely the effect of improving barley tea flavor without losing Job's tears flavor.

TABLE 2

| | | Comparative | | | | Comparative |
|---|---|---|---|---|---|---|
| [Test_2] | Control_1 | Example_3 | Example_3 | Example_4 | Example_5 | Example_4 |
| 2,3-Diethyl-5- | 0.13 | 0.5 | 7 | 50 | 100 | 200 |
| methylpyrazine | | | | | | |
| Concentration | | | | | | |
| Barley Tea | 1.0 | 1.2 | 2.2 | 2.0 | 2.2 | 2.3 |
| Flavor | | | | | | |
| Job's Tears | 4.0 | 3.5 | 2.3 | 3.2 | 2.8 | 2.3 |
| Flavor | | | | | | |

As shown in Table 2, in Examples 3-5, the barley tea flavor was improved in the tea beverages containing Job's tears extract liquid by adding 2,3-diethyl-5-methylpyrazine. Decrease in Job's tears flavor accompanying the improvement of barley tea flavor was also suppressed, and the characteristic flavor of Job's tears was not lost, either.

Meanwhile, in Comparative Example 3 in which 2,3-diethyl-5-methylpyrazine was added at a content of as low as 0.5 ppb, the Job's tears flavor did not decrease while the effect of improving barley tea flavor was barely observed. In Comparative Example 4 in which 2,3-diethyl-5-methylpyrazine was added so that the content thereof was as high as 200 ppb, the barley tea flavor was improved while Job's tears flavor decreased therewith, and characteristic flavor of Job's tears was lost.

### Test 3: Inspection of Effect of 3-methylpyridine

Production of Tea Beverages which were Articles Under Test

Sterilized Job's tears extract liquid was prepared in the same way as in test 1, and 3-methylpyridine was then added to the sterilized Job's tears extract liquid so that the content thereof was 6-200 ppb to produce tea beverages which are test samples. The concentration of 3-methylpyridine contained in the sterilized Job's tears extract liquid before the addition was 1.8 ppb. It is known that this 3-methylpyridine is a fragrance component contained in barley.

The content of 3-methylpyridine in the tea beverage was measured under the following conditions by using a gas chromatograph-mass spectrometer (GC-MS) in the same way as in test 1.

### Analysis Conditions of GC-MS

Apparatus GC: Agilent 7980B GC System (manufactured by Agilent Technologies Japan, Ltd.)
   MS: Agilent 7000D GC/MS Triple Quad (manufactured by Agilent Technologies Japan, Ltd.)
   Collecting tube (adsorbent): Tenax TA, Carbopack-B & Carbopack-X
Column: DB-WAX UI, 20 m×0.18 mm, film thickness: 0.30 μm (manufactured by Agilent Technologies Japan, Ltd.)
Injection method: Splitless
Carrier gas: He (1.0 ml/minute)
Transfer line: 250° C.
Temperature raising program: 40° C. (maintained for 3 minutes)→5° C./minute→240° C. (maintained for 7 minutes)
Precursor ion>product ion (CE (collision energy)): 3-methylpyridine 93>93 (5 V)
Ionizing method: EI
Quadrupole temperature: 150° C.
Ion source temperature: 230° C.

### Sensory Evaluation

Six professional panelists performed the sensory evaluation of the produced tea beverage in the same way as in test 1. Specifically, the “barley tea flavor” and the “Job's tears flavor” were scored on a scale of one to seven separately, and the average values were calculated. The “barley tea flavor” was evaluated by using the prepared sterilized barley extract liquid as a standard (marks: four points) and by using the prepared sterilized Job's tears extract liquid (3-methylpyridine was not added) as a control (marks: one point). The “Job's tears flavor” was evaluated by using the prepared sterilized Job's tears extract liquid (3-methylpyridine was not added) as a standard (marks: four points). It was determined that a tea beverage wherein the “barley tea flavor” was two points or more and “barley tea flavor”<“Job's tears flavor” had an effect, namely the effect of improving barley tea flavor without losing Job's tears flavor.

TABLE 3

| | | Comparative | Comparative | Comparative | Comparative |
|---|---|---|---|---|---|
| [Test_3] | Control_1 | Example_5 | Example_6 | Example_7 | Example_8 |
| 3-Methylpyridine | 1.8 | 6 | 50 | 100 | 200 |
| Concentration | | | | | |
| (ppb) | | | | | |
| Barley Tea | 1.0 | 1.0 | 1.2 | 1.3 | 1.3 |
| Flavor | | | | | |
| Job's Tears | 4.0 | 3.7 | 3.5 | 3.2 | 3.2 |
| Flavor | | | | | |

As shown in Table 3, even though 3-methylpyridine which is a fragrance component contained in barley was added, the tea beverage barely had the effect of improving barley tea flavor. As compared with the addition of 2-ethyl-3,5-dimethylpyrazine in Examples 1 and 2 and the addition of 2,3-diethyl-5-methylpyrazine in Examples 3-5, the effect of improving barley tea flavor was not observed at equivalent contents.

This showed that, among fragrance components, 2-ethyl-3,5-dimethylpyrazine and 2,3-diethyl-5-methylpyrazine can improve barley tea flavor effectively without losing the flavor characteristics of the grain ingredient based on tests 1 and 2.

### Test 4: Inspection of Effect of 2-methylpyrazine

Production of Tea Beverage which was Article Under Test

Sterilized Job's tears extract liquid was prepared in the same way as in test 1, and 2-methylpyrazine was then added to the sterilized Job's tears extract liquid so that the content thereof was 200 ppb to produce a tea beverage which is a test sample. The concentration of 2-methylpyrazine contained in the sterilized Job's tears extract liquid before the addition was 135 ppb. It is known that this 2-methylpyrazine is a fragrance component contained in barley.

The content of 2-methylpyrazine in the tea beverage was measured under the following conditions by using a gas chromatograph-mass spectrometer (GC-MS) in the same way as in test 1.

### Analysis Conditions of GC-MS

Apparatus GC: Agilent 7980B GC System (manufactured by Agilent Technologies Japan, Ltd.)
   MS: Agilent 7000D GC/MS Triple Quad (manufactured by Agilent Technologies Japan, Ltd.)
   Collecting tube (adsorbent): Tenax TA, Carbopack-B & Carbopack-X
Column: DB-WAX UI, 20 m×0.18 mm, film thickness: 0.30 μm (manufactured by Agilent Technologies Japan, Ltd.)
Injection method: Splitless
Carrier gas: He (1.0 ml/minute)
Transfer line: 250° C.
Temperature raising program: 40° C. (maintained for 3 minutes)→5° C./minute→240° C. (maintained for 7 minutes)
Precursor ion>product ion (CE (collision energy)): 2-methylpyrazine 94>67 (10 V)
Ionizing method: EI
Quadrupole temperature: 150° C.
Ion source temperature: 230° C.

### Sensory Evaluation

Six professional panelists performed the sensory evaluation of the produced tea beverage in the same way as in test 1. Specifically, the “barley tea flavor” and the “Job's tears flavor” were scored on a scale of one to seven separately, and the average values were calculated. The “barley tea flavor” was evaluated by using the prepared sterilized barley extract liquid as a standard (marks: four points) and by using the prepared sterilized Job's tears extract liquid (2-methylpyrazine was not added) as a control (marks: one point). The “Job's tears flavor” was evaluated by using the prepared sterilized Job's tears extract liquid (2-methylpyrazine was not added) as a standard (marks: four points). It was determined that a tea beverage wherein the “barley tea flavor” was two points or more and “barley tea flavor”<“Job's tears flavor” had an effect, namely the effect of improving barley tea flavor without losing Job's tears flavor.

TABLE 4

| | | Comparative |
|---|---|---|
| [Test_4] | Control_1 | Example_9 |
| 2-Methylpyrazine | 135 | 200 |
| Concentration (ppb) | | |
| Barley Tea Flavor | 1.0 | 1.0 |
| Job's Tears Flavor | 4.0 | 3.8 |

As shown in Table 4, even though 2-methylpyrazine which is a fragrance component contained in barley was added so that the content thereof was high, the tea beverage barely had the effect of improving barley tea flavor.

This showed that, among fragrance components, 2-ethyl-3,5-dimethylpyrazine and 2,3-diethyl-5-methylpyrazine can improve barley tea flavor effectively without losing the flavor characteristics of the grain ingredient based on tests 1 and 2.

### Test 5: Inspection of Effect of 2,5-dimethylpyrazine

Production of Tea Beverage which was Article Under Test

Sterilized Job's tears extract liquid was prepared in the same way as in test 1, and 2,5-dimethylpyrazine was then added to the sterilized Job's tears extract liquid so that the content thereof was 200 ppb to produce a tea beverage which is a test sample. The concentration of 2,5-dimethylpyrazine contained in the sterilized Job's tears extract liquid before the addition was 8.7 ppb. It is known that this 2,5-dimethylpyrazine is a fragrance component contained in barley.

The content of 2,5-dimethylpyrazine in the tea beverage was measured under the following conditions by using a gas chromatograph-mass spectrometer (GC-MS) in the same way as in test 1.

### Analysis Conditions of GC-MS

Apparatus GC: Agilent 7980B GC System (manufactured by Agilent Technologies Japan, Ltd.)
   MS: Agilent 7000D GC/MS Triple Quad (manufactured by Agilent Technologies Japan, Ltd.)
   Collecting tube (adsorbent): Tenax TA, Carbopack-B & Carbopack-X
Column: DB-WAX UI, 20 m×0.18 mm, film thickness: 0.30 μm (manufactured by Agilent Technologies Japan, Ltd.)
Injection method: Splitless
Carrier gas: He (1.0 ml/minute)
Transfer line: 250° C.
Temperature raising program: 40° C. (maintained for 3 minutes)→5° C./minute→240° C. (maintained for 7 minutes)
Precursor ion>product ion (CE (collision energy)): 2,5-dimethylpyrazine 108>42 (20 V)
Ionizing method: EI
Quadrupole temperature: 150° C.
Ion source temperature: 230° C.

### Sensory Evaluation

Six professional panelists performed the sensory evaluation of the produced tea beverage in the same way as in test 1. Specifically, the “barley tea flavor” and the “Job's tears flavor” were scored on a scale of one to seven separately, and the average values were calculated. The “barley tea flavor” was evaluated by using the prepared sterilized barley extract liquid as a standard (marks: four points) and by using the prepared sterilized Job's tears extract liquid (2,5-dimethylpyrazine was not added) as a control (marks: one point). The “Job's tears flavor” was evaluated by using the prepared sterilized Job's tears extract liquid (2,5-dimethylpyrazine was not added) as a standard (marks: four points). It was determined that a tea beverage wherein the “barley tea flavor” was two points or more and “barley tea flavor”<“Job's tears flavor” had an effect, namely the effect of improving barley tea flavor without losing Job's tears flavor.

TABLE 5

| | | Comparative |
|---|---|---|
| [Test_5] | Control_1 | Example_10 |
| 2,5-Dimethylpyrazine | 8.7 | 200 |
| Concentration (ppb) | | |
| Barley Tea Flavor | 1.0 | 1.0 |
| Job's Tears Flavor | 4.0 | 3.8 |

As shown in Table 5, even though 2,5-dimethylpyrazine, which is a fragrance component contained in barley, was added so that the content thereof was high, the tea beverage barely had the effect of improving barley tea flavor.

This showed that, among fragrance components, 2-ethyl-3,5-dimethylpyrazine and 2,3-diethyl-5-methylpyrazine can improve barley tea flavor effectively without losing the flavor characteristics of the grain ingredient based on tests 1 and 2.

### Test 6: Inspection of Effect of the Combined Use of 2-ethyl-3,5-dimethylpyrazine and 2,3-diethyl-5-methylpyrazine

Production of Tea Beverage which was Article Under Test

Sterilized Job's tears extract liquid was prepared in the same way as in test 1, and 2-ethyl-3,5-dimethylpyrazine and 2,3-diethyl-5-methylpyrazine were then added to the sterilized Job's tears extract liquid at the ratio of 1:1 so that the respective contents were 50 ppb and the total content was accordingly 100 ppb to produce a tea beverage which is a test sample.

The respective contents of 2-ethyl-3,5-dimethylpyrazine and 2,3-diethyl-5-methylpyrazine in the tea beverages were measured by using a gas chromatograph-mass spectrometer (GC-MS) in the same way as in test 1 and test 2.

### Sensory Evaluation

Six professional panelists performed the sensory evaluation of the produced tea beverage in the same way as in test 1. Specifically, the “barley tea flavor” and the “Job's tears flavor” were scored on a scale of one to seven separately, and the average values were calculated. The “barley tea flavor” was evaluated by using the prepared sterilized barley extract liquid as a standard (marks: four points) and by using the prepared sterilized Job's tears extract liquid (2-ethyl-3,5-dimethylpyrazine and 2,3-diethyl-5-methylpyrazine were not added) as a control (marks: one point). The “Job's tears flavor” was evaluated by using the prepared sterilized Job's tears extract liquid (2-ethyl-3,5-dimethylpyrazine and 2,3-diethyl-5-methylpyrazine were not added) as a standard (marks: four points). It was determined that a tea beverage wherein the “barley tea flavor” was two points or more and “barley tea flavor”<“Job's tears flavor” had an effect, namely the effect of improving barley tea flavor without losing Job's tears flavor.

TABLE 6

| [Test_6] | Control_1 | Example_6 |
|---|---|---|
| Total Concentration (ppb) | 1.23 | 100 |
| 2-Ethyl-3,5-dimethylpyrazine | 1.1 | 50 |
| Concentration (ppb) | | |
| 2,3-Diethyl-5-methylpyrazine | 0.13 | 50 |
| Concentration (ppb) | | |
| Barley Tea Flavor | 1.0 | 2.0 |
| Job's Tears Flavor | 4.0 | 3.0 |

As shown in Table 6, in Example 6, the barley tea flavor was improved in the tea beverage containing Job's tears extract liquid by adding 2-ethyl-3,5-dimethylpyrazine and 2,3-diethyl-5-methylpyrazine in combination. Decrease in Job's tears flavor accompanying the improvement of barley tea flavor was also suppressed, and the characteristic flavor of Job's tears was not lost, either.

### Test 7: Inspection of Effect when Grain Component was Corn

### (Preparation of Corn Extract Liquid)

90 g of roasted corn (L value: 56) was subjected to extraction with 2700 g of pure water at 90° C., the resultant was filtered through a filter No. 2, and then cooled to obtain an extract liquid. To the obtained extract liquid were added 2.7 g of L-sodium ascorbate, 0.9 g of L-ascorbic acid, and 1.8 g of sodium bicarbonate, and the mixture was diluted to 9000 g with pure water to obtain a preparation liquid. The obtained preparation liquid was sterilized with UHT (at 140° C. for 30 seconds) and then aseptically filled into a bottle to obtain sterilized corn extract liquid. The concentration of 2,3-diethyl-5-methylpyrazine contained in the obtained sterilized corn extract liquid was 0.28 ppb.

Production of Tea Beverages which were Articles Under Test

To the sterilized corn extract liquid was added 2,3-diethyl-5-methylpyrazine so that the content thereof was 100-200 ppb to produce a tea beverage which is a test sample.

The content of 2,3-diethyl-5-methylpyrazine in the tea beverage was measured by using a gas chromatograph-mass spectrometer (GC-MS) in the same way as in test 2.

### Sensory Evaluation

Six professional panelists performed the sensory evaluation of the produced tea beverage in the same way as in the above-mentioned test 1. Specifically, the “barley tea flavor” and the “corn flavor” were scored on a scale of one to seven separately, and the average values were calculated. The “barley tea flavor” was evaluated by using the prepared sterilized barley extract liquid as a standard (marks: four points) and by using the prepared sterilized corn extract liquid (2,3-diethyl-5-methylpyrazine was not added) as a control (marks: one point). The “corn flavor” was evaluated by using the prepared sterilized corn extract liquid (2,3-diethyl-5-methylpyrazine was not added) as a standard (marks: four points). It was determined that a tea beverage wherein the “barley tea flavor” was two points or more and “barley tea flavor”<“corn flavor” had an effect, namely the effect of improving barley tea flavor without losing corn flavor.

TABLE7

| | | | Reference |
|---|---|---|---|
| [Test_7] | Control_1 | Example_7 | Example_1 |
| 2,3-Diethyl-5- | 0.28 | 100 | 200 |
| methylpyrazine | | | |
| Concentration (ppb) | | | |
| Barley Tea Flavor | 1.0 | 2.0 | 2.0 |
| Corn Flavor | 4.0 | 3.0 | 2.3 |

As shown in Table 7, in Example 7, the barley tea flavor was improved in the tea beverages by adding 2,3-diethyl-5-methylpyrazine to corn extract liquid. Decrease in corn flavor accompanying the improvement of barley tea flavor was also suppressed, and the characteristic flavor of corn was not lost, either. As shown in Reference Example 1, when the tea beverage contained the extract liquid of corn, which is a grain, even though 2,3-diethyl-5-methylpyrazine was added so that the content thereof was as high as 200 ppb, decreases in corn flavor was suppressed, and the barley tea flavor was improved without losing the characteristic flavor of corn.

### Test 8: Inspection of Effect when Grain Component was Brown Rice

### Preparation of Brown Rice Extract Liquid

90 g of roasted brown rice (L value: 46.5) was subjected to extraction with 2700 g of pure water at 90° C., the resultant was filtered through a filter No. 2, and then cooled to obtain an extract liquid. To the obtained extract liquid were added 2.7 g of L-sodium ascorbate, 0.9 g of L-ascorbic acid, and 1.8 g of sodium bicarbonate, and the mixture was diluted to 9000 g with pure water to obtain a preparation liquid. The obtained preparation liquid was sterilized with UHT (at 140° C. for 30 seconds) and then aseptically filled into a bottle to obtain sterilized brown rice extract liquid. The concentration of 2,3-diethyl-5-methylpyrazine contained in the obtained sterilized brown rice extract liquid was 0.24 ppb.

Production of Tea Beverages which were Articles Under Test

To the sterilized brown rice extract liquid was added 2,3-diethyl-5-methylpyrazine so that the content thereof was 100 ppb to produce a tea beverage which is a test sample.

The content of 2,3-diethyl-5-methylpyrazine in the tea beverages was measured by using a gas chromatograph-mass spectrometer (GC-MS) in the same way as in test 2.

### Sensory Evaluation

Six professional panelists performed the sensory evaluation of the produced tea beverage in the same way as in the above-mentioned test 1. Specifically, the “barley tea flavor” and the “brown rice flavor” were scored on a scale of one to seven separately, and the average values were calculated. The “barley tea flavor” was evaluated by using the prepared sterilized barley extract liquid as a standard (marks: four points) and by using the prepared sterilized brown rice extract liquid (2,3-diethyl-5-methylpyrazine was not added) as a control (marks: one point). The “brown rice flavor” was evaluated by using the prepared sterilized brown rice extract liquid (2,3-diethyl-5-methylpyrazine was not added) as a standard (marks: four points). It was determined that a tea beverage wherein the “barley tea flavor” was two points or more and “barley tea flavor”<“brown rice flavor” had an effect, namely the effect of improving barley tea flavor without losing brown rice flavor.

TABLE 8

| | | | Comparative |
|---|---|---|---|
| [Test_8] | Control_1 | Example_8 | Example_11 |
| 2,3-Diethyl-5- | 0.24 | 100 | 200 |
| methylpyrazine | | | |
| Concentration (ppb) | | | |
| Barley Tea Flavor | 1.0 | 2.0 | 2.3 |
| Brown Rice Flavor | 4.0 | 2.7 | 1.8 |

As shown in Table 8, in Example 8, the barley tea flavor was improved in the tea beverage by adding 2,3-diethyl-5-methylpyrazine to brown rice extract liquid. Decrease in brown rice flavor accompanying the improvement of barley tea flavor was also suppressed, and the characteristic flavor of brown rice extract liquid was not lost, either.

1. A tea beverage containing an extract derived from a grain other than barley, comprising:
one or both of 2-ethyl-3,5-dimethylpyrazine and 2,3-diethyl-5-methylpyrazine,
wherein a content of the 2-ethyl-3,5-dimethylpyrazine is 8-100 ppb, and
a content of the 2,3-diethyl-5-methylpyrazine is 0.7-100 ppb.

2. The tea beverage according to claim 1, wherein the grain is one or more selected from the group consisting of Job's tears, brown rice, and corn.

3. A method for producing a tea beverage containing an extract derived from a grain other than barley, the method comprising:
extracting a grain extract liquid from a feedstock grain other than barley; and
adding one or both of 2-ethyl-3,5-dimethylpyrazine and 2,3-diethyl-5-methylpyrazine to the grain extract liquid so that a content of the 2-ethyl-3,5-dimethylpyrazine is 8-100 ppb and a content of the 2,3-diethyl-5-methylpyrazine is 0.7-100 ppb.

4. A method for improving barley tea flavor of a tea beverage, comprising adding one or both of 2-ethyl-3,5-dimethylpyrazine and 2,3-diethyl-5-methylpyrazine to a tea beverage containing an extract derived from a grain other than barley so that a content of the 2-ethyl-3,5-dimethylpyrazine is 8-100 ppb and a content of the 2,3-diethyl-5-methylpyrazine is 0.7-100 ppb.
